(19) United States
(12) Patent Application Publication
(10) Pub. No.: US 2009/0193850 A1
(43) Pub. Date: Aug. 6, 2009

(54) Heating apparatus and glass manufacturing method

(75) Inventor: Ryousuke Sakai, Sagamihara-shi (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Ohara Inc.

(21) Appl. No.: 12/320,584

(22) Filed: Jan. 29, 2009

(30) Foreign Application Priority Data
Jan. 31, 2008 (JP) 2008-021448

(51) Int. Cl. C03B 11/12; C03B 9/38; C03B 19/00

(52) U.S. Cl. 65/66; 65/355; 65/319

(57) ABSTRACT

The present invention aims to provide a heating apparatus that can sufficiently suppress the occurrence of striae and the deterioration of optical properties, and that can reduce the maintenance burden. A heating apparatus 10 that is used for heating a flow path 90 for flowing out the molten glass includes an inner wall 21 which forms an entry hole 29 that a tip 91 of the flow path 90 can enter, heating portions 30 for heating the inner wall 21, and a high radiation portion 40 that is made of a high emissivity material. The high radiation portion 40 is arranged so as to face the tip 91 of the flow path 90 as well as a lower part thereof with a space therebetween when the heating apparatus 10 is used.

### CROSS-REFERENCE RELATED APPLICATIONS

This application is based on and claims the benefit of priority from Japanese Patent Application No. 2008-021448, filed on 31 Jan. 2008, the content of which is incorporated herein by reference.

### BACKGROUND OF THE INVENTION

1. Field of the Invention

The present invention relates to a heating apparatus that is used for heating a flow path for flowing out molten glass, and to a glass manufacturing method.

2. Description of the Related Art

A general molten glass feeding apparatus includes a holding vessel for accommodating molten glass, and this holding vessel is provided with a flow path. As a result, the molten glass in the holding vessel flows out of the flow path to the exterior.

In this case, if the temperature of the flow path is low, the molten glass located in the vicinity of the inner wall of the flow path is cooled to a higher extent, while the molten glass positioned in a central portion away from the inner wall is cooled to a lower extent. As a result, since the temperature distribution in the molten glass flowed out of the flow path becomes uneven, there is concern that striae may occur. Moreover, there is also a concern that the optical properties of the manufactured glass products may be deteriorated by crystallization occurring in the glass.

Accordingly, a countermeasure has been adopted whereby a heater is arranged around the flow path in order to heat the flow path (e.g., Patent Documents 1 to 3).

[Patent Document 1] Japanese Unexamined Patent Application, First Publication No. H8-109028

[Patent Document 2] Japanese Unexamined Patent Application, First Publication No. H8-133751

[Patent Document 3] Japanese Unexamined Patent Application, First Publication No. 2002-348124

### SUMMARY OF THE INVENTION

However, the configurations described in Patent Documents 1 to 3 cannot sufficiently suppress the occurrence of striae and the deterioration of optical properties. The inventors have found that the primary cause of this is a rapid reduction in temperature at the tip of the flow path.

A countermeasure may be considered whereby the heater is physically in contact with the flow path in order to further heat the tip of the flow path. However, as a result of such a countermeasure, the molten glass may flow toward the heater instead of flowing down from the tip of the flow path. Once the molten glass starts to flow toward the heater, the high viscosity thereof makes it difficult for the molten glass to naturally resume flowing down. Accordingly, it is anticipated that maintenance has to be frequently carried out for resuming the flowing down of the molten glass.

The present invention has been made in view of the above-mentioned facts, and has an object thereof to provide a heating apparatus and a glass manufacturing method that can sufficiently suppress the occurrence of striae and the deterioration of optical properties, and can reduce the maintenance burden.

The inventors have found that the reduction in temperature at the tip of the flow path is significantly mitigated by providing a heated surface of high temperature so as to face the tip of the flow path as well as a lower part thereof with a space therebetween, thereby completing the present invention. More specifically, the present invention provides the following.

According to a first aspect of the present invention, a heating apparatus used for heating a flow path for flowing out molten glass, includes: an inner wall which forms an entry hole that a tip of the flow path can enter; a heating means for heating the inner wall; and a high radiation portion made of a high emissivity material, in which the high radiation portion is arranged so as to face the tip of the flow path as well as a lower part thereof with a space therebetween.

According to a second aspect of the present invention, in the heating apparatus according to the first aspect, the high radiation portion is provided on a surface of the inner wall.

According to a third aspect of the present invention, in the heating apparatus according to the first aspect, the high radiation portion is provided to be separated from the inner wall, and is disposed so as to be positioned between the inner wall and the tip of the flow path as well as a lower part thereof.

According to a fourth aspect of the present invention, in the heating apparatus according to any one of the first to third aspects, the high radiation portion is provided over an entirety in a circumferential direction of the inner wall.

According to a fifth aspect of the present invention, in the heating apparatus according to any one of the second to fourth aspects, the high radiation portion has a substantially constant dimension in a direction in which the inner wall extends.

According to a sixth aspect of the present invention, in the heating apparatus according to the fifth aspect, the high radiation portion is provided in a substantially constant range in the direction in which the inner wall extends.

According to a seventh aspect of the present invention, in the heating apparatus according to any one of the first to sixth aspects, the high radiation portion has a protruding portion that protrudes inwardly.

According to an eighth aspect of the present invention, the heating apparatus according to any one of the first to seventh aspects is further includes a high conductivity portion made of a high conductivity material and to be heated, in which the high conductivity portion is connected to a base side of the flow path to enable heat conduction.

According to a ninth aspect of the present invention, in the heating apparatus according to the eighth aspect, the high conductivity portion is a part of the inner wall or a part that is connected to the inner wall to enable heat conduction.

According to a tenth aspect of the present invention, in the heating apparatus according to the ninth aspect, the high conductivity portion is a non-inner-wall portion that is connected to the inner wall to enable heat conduction.

According to an eleventh aspect of the present invention, in the heating apparatus according to any one of the first to tenth aspects, the high emissivity material has an emissivity of at least 0.4.

According to a twelfth aspect of the present invention, a glass manufacturing apparatus includes: a flow path for flowing out molten glass; the heating apparatus according to any one of the first to eleventh aspects; and a mold, in which the high radiation portion is arranged so as to face a tip of the flow path as well as a lower part thereof with a space therebetween, and in which the mold molds molten glass flowed out of the flow path.

According to a thirteenth aspect of the present invention, an optical element manufacturing apparatus includes: the glass manufacturing apparatus according to the twelfth aspect; and a precision press apparatus that performs precision pressing of glass manufactured by the glass manufacturing apparatus.

According to a fourteenth aspect of the present invention, in a glass manufacturing method in which molten glass is flowed out of a tip of a flow path to manufacture glass, the method includes steps of: arranging a target heated surface, which is to be heated, so as to face the tip of the flow path as well as a lower part thereof with a space therebetween; and heating the target heated surface.

According to a fifteenth aspect of the present invention, the glass manufacturing method according to the fourteenth aspect includes steps of: providing a high radiation portion made of a high emissivity material to the target heated surface; arranging the high radiation portion so as to face the tip of the flow path as well as a lower part thereof with a space therebetween; and heating the high radiation portion.

According to a sixteenth aspect of the present invention, in the glass manufacturing method according to the fifteenth aspect, a material with an emissivity of at least 0.4 is used as the high emissivity material.

According to a seventeenth aspect of the present invention, in the glass manufacturing method according to the fifteenth or sixteenth aspect, the high radiation portion is arranged over an entirety in a circumferential direction of the flow path.

According to an eighteenth aspect of the present invention, in the glass manufacturing method according to the seventeenth aspect, the high radiation portion is arranged in a substantially constant dimension in a direction in which the flow path extends.

According to a nineteenth aspect of the present invention, in the glass manufacturing method according to the eighteenth aspect, the high radiation portion is arranged in a substantially constant range in a direction in which the flow path extends.

According to a twentieth aspect of the present invention, in the glass manufacturing method according to any one of the fourteenth to nineteenth aspects, the target heated surface is arranged so as to protrude toward the tip of the flow path as well as a lower part thereof.

According to a twenty-first aspect of the present invention, the glass manufacturing method according to any one of the fourteenth to twentieth aspects further includes steps of: connecting a high conductivity portion made of a high conductivity material to a base side of the flow path to enable heat conduction; and heating the high conductivity portion directly or indirectly.

According to a twenty-second aspect of the present invention, in the glass manufacturing method according to the twenty-first aspect, the high conductivity portion is connected to a part of the target heated surface or a part that is connected to the target heated surface to enable heat conduction.

According to a twenty-third aspect of the present invention, in the glass manufacturing method according to the twenty-second aspect, the high conductivity portion, which is positioned on a non-facing portion that does not face the flow path, is connected to a base side of the flow path to enable heat conduction.

According to a twenty-fourth aspect of the present invention, an optical element manufacturing method includes a step of performing precision press molding of the glass manufactured with the glass manufacturing method according to any one of the fourteenth to twenty-third aspects.

According to the present invention, since the high radiation portion is arranged to be separated from the flow path with a space therebetween, the molten glass flowing to the heating apparatus is not anticipated. In addition, when heated by the heating means, the high radiation portion radiates a large amount of heat energy. Here, since the high radiation portion is arranged so as to face the tip of the flow path and a lower part thereof, a large amount of heat energy reaches the tip from various directions such as the side and beneath. As a result, even though the heating apparatus is separated from the flow path with a space therebetween, the tip of the flow path is efficiently heated, thereby significantly mitigating the temperature reduction.

Consequently, it is possible to sufficiently suppress the occurrence of striae and the deterioration of optical properties, and to reduce the maintenance burden.

### BRIEF DESCRIPTION OF THE DRAWINGS

FIG. 1 is a diagram showing a schematic configuration of a heating apparatus according to a first embodiment of the present invention;

FIG. 2 is a cross-sectional view taken along a line II-II of FIG. 1;

FIG. 3 is a cutaway perspective view of FIG. 1;

FIG. 4 is a diagram showing a schematic configuration of a heating apparatus according to a second embodiment of the present invention;

FIG. 5 is a diagram showing a schematic configuration of a heating apparatus according to a third embodiment of the present invention;

FIG. 6 is a diagram showing a schematic configuration of a heating apparatus according to a modified example of the present invention;

FIG. 7 is a cutaway perspective view of FIG. 6; and

FIG. 8 is a cutaway perspective view of a heating apparatus according to another modified example of the present invention.

### DETAILED DESCRIPTION OF THE INVENTION

Preferred embodiments of the present invention will be described hereinafter with reference to the attached drawings. It should be noted that, in the description of each embodiment other than the first embodiment, elements which are common to the first embodiment are assigned the same reference numerals, and descriptions thereof are omitted.

### First Embodiment

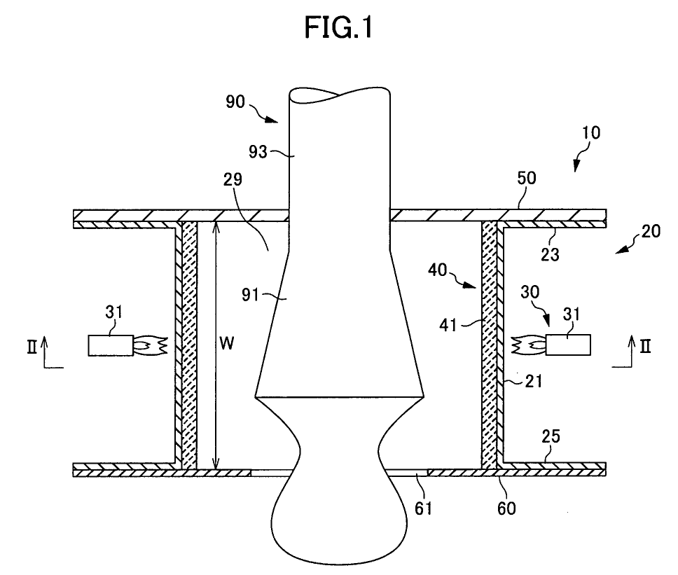

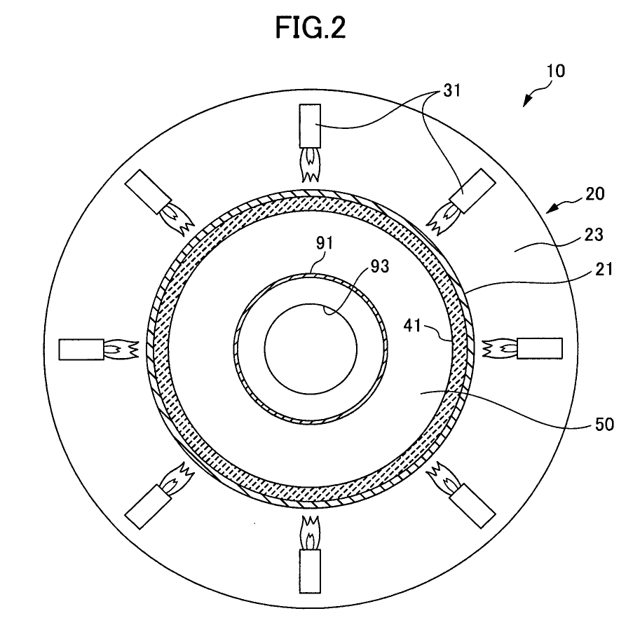

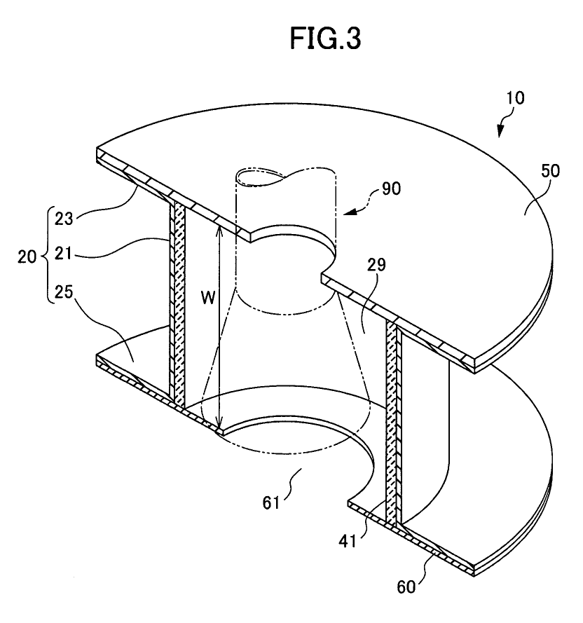

FIG. 1 is a diagram showing a schematic configuration of a heating apparatus 10 according to a first embodiment of the present invention. FIG. 2 is a cross-sectional view taken along a line II-II of FIG. 1, and FIG. 3 is a cutaway perspective view of FIG. 1.

The heating apparatus 10 includes an enclosure 20, heating portions 30 as a heating means, and a high radiation portion 40. Each component is described in detail as follows.

### Enclosure

The enclosure 20 has an inner wall 21 that forms an entry hole 29, and a tip 91 of a flow path 90 can enter the entry hole 29. Although the entry hole 29 is configured as a cylindrical shape in the present embodiment as shown in FIG. 2, it is not particularly limited thereto, and the entry hole 29 may by appropriately designed depending on the shape of the tip 91 of the flow path 90 to be used. However, the diameter of the entry hole 29 needs to be greater than the diameter of the tip 91, so that the high radiation portion 40 faces the tip 91 with a space therebetween.

In the present embodiment, the inner wall 21 forms the entirety of the entry hole 29 (in other words, being an entire circular arc in a plan view). As a result, the entire perimeter of the flow path 90 is substantially evenly heated by means of the high radiation portion 40 or a high conductivity portion 50 to be described later. However, there may also be a configuration in which the inner wall 21 forms only part of the entry hole 29 (in other words, being a partial circular arc in a plan view).

An upper wall 23 is connected to the upper edge of the inner wall 21, and a lower wall 25 is connected to the lower edge of the inner wall 21, with the upper wall 23 and the lower wall 25 facing each other. The heating portions 30 to be described later are arranged at positions surrounded by the inner wall 21, the upper wall 23 and the lower wall 25, respectively. As a result, external radiation of the heat energy generated by the heating portions 30 is suppressed, and the inner wall 21 is heated with high efficiency.

It is not particularly limited as long as the reaction with a high conductivity portion 50 is less likely to cause deterioration, however, it is preferable for the inner wall 21 and the upper wall 23 to be connected via a highly heat-conductive material such as platinum, rhodium, gold, silver, copper and titanium, from the viewpoint that the heating efficiency of the flow path 90 can be improved. This makes it easy for the heat energy to be conducted from the heated inner wall 21 to the upper wall 23. As a result, a large amount of heat energy is conducted to a base 93 via the high conductivity portion 50 to be described later. It should be noted that the entirety of the enclosure 20 is formed from a highly heat-conductive material in the present embodiment. In addition, since the enclosure 20 continues to be exposed to heating at a high temperature, it is preferable for the enclosure 20 to be formed from a material which is superior in thermal resistance.

### Heating Portions

The heating portions 30 each have a burner 31. Each of the burners 31 is provided with a gas supply portion and an ignition portion, which are not illustrated. As a result, the fuel gas supplied from the gas supply portions to the burners 31 is ignited by the ignition portions. Since the burners 31 are arranged so that the openings thereof face the inner wall 21, flames fired by the ignition portions reach the inner wall 21, thereby heating the inner wall 21. It should be noted that the above-mentioned configuration can be achieved by employing conventionally known means.

As shown in FIG. 2, the burners 31 are arranged so that the openings thereof align at substantially regular intervals around the concentric circle with the entry hole 29 as the center thereof. Accordingly, the entirety of the inner wall 21 is substantially evenly heated, resulting in the entire perimeter of the tip 91 is substantially evenly heated, thereby making it possible to sufficiently suppress the occurrence of striae and the deterioration of optical properties. The interval between the openings may be appropriately set depending on the heating capability of the burners 31 and the like.

It should be noted that the arrangement of the burners 31 is not particularly limited. For example, the openings are arranged at intervals in the present embodiment; however, the openings may be arranged overall without an interval, and are preferably arranged at substantially regular intervals, but not limited thereto. Moreover, the number of the openings to be arranged is not particularly limited either. For example, in relation to the direction in which the inner wall 21 extends, one opening is arranged in a substantially central position of the inner wall 21 in the present embodiment, but the opening may be arranged non-centrally, or a plurality of openings may be arranged.

### High Radiation Portion

The high radiation portion 40 is provided on the surface of the inner wall 21 in the present embodiment. As a result, the heat energy is directly conducted from the heated inner wall 21 to the high radiation portion 40, thereby heating the high radiation portion 40 with high efficiency.

Moreover, the high radiation portion 40 is made of a high emissivity material. The high emissivity material indicates a material having emissivity of at least 0.40, preferably at least 0.50, and more preferably at least 0.60. More specifically, examples of such a material include an oxide, nitride and carbide of metals and alloys such as aluminum, nickel, titanium, stainless steel and nichrome; multi-component glass containing silica, silicate, borosilicate and the like; and fire clay and the like; or a glass film containing pigment as described in Japanese Unexamined Patent Application, First Publication No. H11-201649. The high radiation portion 40 is formed by means such as by molding the high emissivity materials to a predetermined shape to be bonded to the inner wall 21, or depositing onto the inner wall 21 by a deposition method such as sputtering or vacuum deposition, oxidizing the surface of the inner wall 21 made of a highly conductive material, heating the surface of the inner wall 21 and applying glass in a softened state thereto, or applying a clayey refractory to the inner wall 21. The high radiation portion 40 that is formed from these high emissivity materials radiates a large amount of heat energy from the inner wall 21. It should be noted that the surface of the high radiation portion 40 may be either a smooth surface or a rough surface. Moreover, the high radiation portion 40 may be a porous body, and minute air spaces of the porous body may contain a gas or a liquid for enhancing the emissivity.

Such a high radiation portion 40 is arranged so as to face the tip 91 as well as a lower part thereof with a space therebetween when the heating apparatus 10 is used. As a result, the heat energy radiated from the high radiation portion 40 efficiently reaches the tip 91, thereby significantly mitigating the temperature reduction of the tip 91.

Here, the high radiation portion 40 in the present embodiment is configured only with a body part 41 that has substantially the same shape with the surface of the inner wall 21, and the body part 41 is provided over the entirety in a circumferential direction of the inner wall 21 as shown in FIG. 2. As a result, the tip 91 and the lower part thereof are surrounded by the high radiation portion 40, thereby suppressing local heating of the molten glass in the tip 91. In the present embodiment in particular, the inner wall 21 forms the entirety of the entry hole 29 as described above, and therefore the entirety of the tip 91 and the lower part thereof is surrounded by the high radiation portion 40. As a result, the molten glass in the tip 91 is extremely evenly heated.

When describing in more detail, the high radiation portion 40 in the present embodiment, as shown in FIG. 3, has a substantially constant dimension W in a direction in which the inner wall 21 extends (the vertical direction in FIG. 3). As a result, the tip 91 and a lower part thereof are surrounded by the high radiation portion 40 that has a substantially constant width W, thereby radiating heat energy substantially evenly to the tip 91. Accordingly, the molten glass in the tip 91 is heated more evenly.

The high radiation portion 40 in the present embodiment is provided in a substantially constant range, and more specifically in an overall range in the direction in which the inner wall 21 extends. As a result, the molten glass in the flow path 90 is evenly heated at substantially the same timing in the process until being flowed out of the flow path 90.

The heating apparatus 10 according to the present embodiment further includes the high conductivity portion 50 that conducts heat energy to the base 93, and a shielding portion 60 that reduces exposure of the tip 91 to the outside atmosphere.

### High Conductivity Portion

The high conductivity portion 50 is formed with a high conductivity material such as platinum, rhodium, gold, silver, copper and titanium.

The high conductivity portion 50 is provided to be adhered on the upper wall 23 (in other words, it is a non-inner-wall portion). As a result, if the inner wall 21 and the upper wall 23 are connected via a high conductivity material as described above, the heat energy is conducted from the inner wall 21 to the high conductivity portion 50, thereby heating the high conductivity portion 50. However, it is not limited thereto, and a heating apparatus that is different from the heating portion 30 may be provided to heat the high conductivity portion 50 secondarily or independently.

Here, an insertion hole, into which the base 93 can be inserted, is formed in the high conductivity portion 50. When the base 93 is inserted into this insertion hole, the high conductivity portion 50 comes into contact with the base 93 side of the flow path 90, thereby establishing a state in which heat conduction is possible. As a result, the heat energy is conducted from the heated high conductivity portion 50 to the base 93 side, thereby heating the base 93 side as well.

It should be noted that, though the high conductivity portion 50 is shaped like a doughnut and is connected to enable heat conduction to the entire perimeter of the base 93 in the present embodiment, it is not limited thereto, and the high conductivity portion 50 may be connected to enable heat conduction to only a partial perimeter of the base 93. However, the configuration in which the high conductivity portion 50 is connected to enable heat conduction to the entire perimeter of the base 93 is preferable from the viewpoint that the entire perimeter of the base 93 is substantially evenly heated. It should be noted that, although the insertion hole is configured as a cylindrical shape in the present embodiment as shown in FIG. 3, it is not particularly limited thereto, and the insertion hole may be appropriately designed depending on the shape of the base 93 of the flow path 90 to be used.

Moreover, the high conductivity portion 50 as a whole may be either one body or separate bodies. The high conductivity portion 50 configured with separate bodies is preferable from the viewpoint that the high conductivity portion 50 can be easily connected to and detached from the base 93, even in a case in which the diameter of the tip 91 is greater than the diameter of the base 93 as shown in FIG. 1. Moreover, the high conductivity portion 50 configured with one body is preferable from the viewpoint that the high conductivity portion 50 is hard to separate from the base 93 once connected to the base 93.

### Shielding Portion

The shielding portion 60 is a member that is shaped like a doughnut extending from the lower wall 25 to the entry hole 29 side. As a result, the extent of exposure of the tip 91 to the outside atmosphere is reduced, and the heat radiation of the tip 91 is suppressed, thereby making it possible to suppress the occurrence of striae and the deterioration of optical properties more sufficiently.

If an outlet hole 61 that is formed in the shielding portion 60 is narrower, the heat radiation of tip 91 can be reduced with higher efficiency. However, the dimension of the outlet hole 61 may be set to be greater than the diameter of the tip 91 by taking into consideration that the molten glass flowed out of the tip 91 may adhere to the shielding portion 60 in a case where the outlet hole 61 is excessively narrow.

The shielding portion 60 may be made of a high emissivity material, and in addition, it is preferable for the shielding portion 60 to be provided to adhere to the lower wall 25. As a result, the heat energy conducted from the lower wall 25 to the shielding portion 60 is radiated in ample amounts, and part of the heat energy reaches the tip 91, thereby heating the tip 91 more efficiently. In this case, it is preferable that the inner wall 21 and the lower wall 25 are connected via a high conductivity member, from the viewpoint that the heat energy conducted to the lower wall 25 can be sufficiently secured.

It should be noted that, though the shielding portion 60 extends in the horizontal direction in the present embodiment as shown in FIG. 1, it is not limited thereto, and the shielding portion 60 may extend in an arbitrary direction so that the atmospheric temperature around the tip 91 becomes appropriate.

### Glass Manufacturing Method

Next, a glass manufacturing method according to one embodiment of the present invention is described for a case in which the heating apparatus 10 is used.

Initially, the inner wall 21 as a target heated surface is arranged so as to face the tip 91 as well as a lower part thereof with a space therebetween. This establishes a state in which the tip 91 of the flow path 90 can be heated by the radiant heat from the heated inner wall 21. In the present embodiment, the high radiation portion 40 provided to the inner wall 21 is arranged over the entirety in a circumferential direction of the flow path 90, and is arranged for a substantially constant dimension and in a substantially constant range in the direction in which the flow path extends.

Moreover, the high conductivity portion 50 is made to contact with and be connected to the base 93 to enable heat conduction therebetween. At this time, the high conductivity portion 50 is positioned on a portion that is connected to the inner wall 21 to enable heat conduction therebetween, and more specifically, on the upper wall 23 that is a non-facing portion that does not face the flow path 90. It should be noted that, in a case where the high conductivity portion 50 is configured to be one body, the high conductivity portion 50 may be inserted from the base side of the flow path 90, and in a case where the high conductivity portion 50 is configured to be separate bodies, each body may be attached to the base 93, and joined thereafter.

Moreover, the shielding portion 60 is arranged toward the lower side of the tip 91. At this time, the shielding portion 60 should be arranged in a position that does not come into contact with the molten glass flowed out of the tip 91.

Next, the heating portions 30 are operated to carry out ignition. As a result, the inner wall 21 is heated, and the heat energy is conducted to the high radiation portion 40, thereby heating the high radiation portion 40. Then, a large amount of heat energy is radiated from the high radiation portion 40 and reaches the tip 91, thereby efficiently heating the tip 91. Moreover, since the heat energy is conducted from the inner wall 21 to the high conductivity portion 50 as well via the upper wall 23, the heat energy is conducted from the high conductivity portion 50 to the base 93 side, thereby heating the base 93 side as well.

In this state, the molten glass starts to be fed from the base 93 side, and the molten glass is flowed out of the tip 91 downward. Since the tip 91 is efficiently heated as described above, the temperature reduction of the molten glass in the tip 91 is significantly mitigated. Moreover, since the base 93 side is heated as well, the occurrence of crystallization in the molten glass before the flowing out is further suppressed.

The molten glass is flowed out of the tip 91 in this way, and is molded in a mold which is not illustrated, thereby manufacturing glass. It should be noted that the flow path 90, the heating apparatus 10 and the mold constitute a glass manufacturing apparatus.

Since the molten glass is flowed out of the tip 91 in a state in which the occurrence of crystallization and the temperature reduction are suppressed, the occurrence of striae and the deterioration of optical properties are sufficiently suppressed in the glass that is manufactured in the present embodiment. As a result, the glass that is manufactured in the present embodiment can be preferably used for an optical element, and more specifically, it is possible to manufacture an optical element by precision press molding of the glass. It should be noted that the aforementioned glass manufacturing apparatus and the precision press apparatus to be used for precision press molding constitute an apparatus for manufacturing an optical element.

### Operation/Working-Effect

According to the present embodiment, the following operational effects can be achieved.

Since the high radiation portion 40 is arranged to be separated from the flow path 90 with a space therebetween, molten glass flowing to the heating apparatus 10 is not anticipated. Moreover, the high radiation portion 40 radiates a large amount of heat energy when heated by the heating portions 30. Here, since the high radiation portion 40 is arranged so as to face the tip 91 of the flow path 90 and a lower part thereof, a large amount of heat energy reaches the tip 91 from various directions such as the side and beneath. As a result, although the heating apparatus 10 is separated from the flow path 90 with a space therebetween, the tip 91 of the flow path 90 is efficiently heated, thereby significantly mitigating the temperature reduction.

Therefore, it is possible to sufficiently suppress the occurrence of striae and the deterioration of optical properties, and to reduce the maintenance burden.

Since the high radiation portion 40 is provided on the surface of the inner wall 21, the heat energy is directly conducted from the heated inner wall 21 to the high radiation portion 40, thereby heating the high radiation portion 40 with high efficiency. As a result, a sufficient amount of heat energy is radiated, thereby making it possible to suppress the occurrence of striae and the deterioration of optical properties more sufficiently.

Since the high radiation portion 40 is provided over the entirety in a circumferential direction of the inner wall 21, the tip 91 of the flow path 90 and a lower part thereof are surrounded by the high radiation portion 40. As a result, the local heating of the molten glass is suppressed, thereby making it possible to suppress the occurrence of striae and the deterioration of optical properties more sufficiently.

Since the high radiation portion 40 is configured to have a dimension W that is substantially constant in the direction in which the inner wall 21 extends, the tip 91 of the flow path 90 and a lower part thereof are surrounded by the high radiation portion 40 with the substantially constant width W. As a result, since substantially even heat energy is radiated to the tip 91 of the flow path 90, the molten glass is more evenly heated, thereby making it possible to suppress the occurrence of striae and the deterioration of optical properties more sufficiently.

Since the high radiation portion 40 is provided in a substantially constant range in the direction in which the inner wall 21 extends, the molten glass is evenly heated at substantially the same timing in the process of moving in the flow path 90 to be flowed out of the flow path 90. This makes it possible to suppress the occurrence of striae and the deterioration of optical properties more sufficiently.

Since the high conductivity portion 50 is connected to the base 93 side of the flow path 90 to enable heat conduction, the heat energy is conducted from the heated high conductivity portion 50 to the base 93 side of the flow path 90. As a result, the base 93 side of the flow path 90 is heated as well, and the occurrence of crystallization in the molten glass before the flowing out is further suppressed. Therefore, it is possible to suppress the deterioration of optical properties more sufficiently.

When the inner wall 21 is heated by the heating portions 30, the high conductivity portion 50, which is connected to the inner wall 21 to enable heat conduction, is also heated. This reduces the necessity for separately heating the heat high conductivity portion 50, thereby making it possible to improve the overall energy efficiency of the heating apparatus 10. Moreover, if an apparatus for separately heating the high conductivity portion 50 is not provided, the initial cost can be reduced as well.

It should be noted that, if heating of the inner wall 21 reaches an excessive amount, the heat energy conducted from the high conductivity portion 50 to the base 93 side becomes excessive, and instead there is a risk of inducing striae. However, in the present embodiment, due to the tip 91 of the flow path 90 being efficiently heated by the high radiation portion 40, it is possible to curb the extent of heating of the inner wall 21 that is necessary. Therefore, it is possible to obtain the aforementioned effects without inducing striae.

Since the high conductivity portion 50 is not provided to the inner wall 21, a wider area of the inner wall 21 faces the flow path 90. As a result, a larger amount of heat energy is radiated from the entire inner wall 21 and reaches the flow path 90, thereby making it possible to suppress the occurrence of striae more sufficiently.

### Second Embodiment

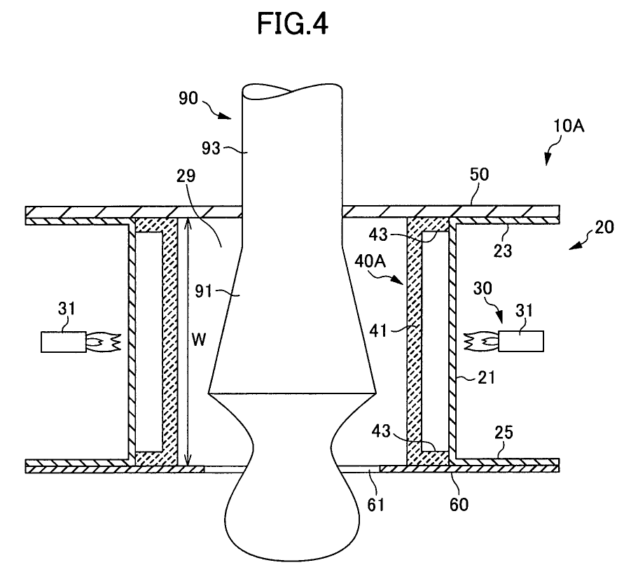

FIG. 4 is a diagram showing a schematic configuration of a heating apparatus 10A according to a second embodiment of the present invention. The present embodiment is different from the first embodiment in that a separation portion 43 is provided.

That is to say, the separation portion 43 is made to protrude to the inner wall 21, and a body portion 41 of a high radiation portion 40A is provided on the separation portion 43. As a result, the high radiation portion 40A is separated from the inner wall 21. When using such a heating apparatus 10A, the high radiation portion 40A is arranged so as to be positioned between the inner wall 21 and the tip 91 as well as a lower part thereof. At this time, the high radiation portion 40A becomes closer to the tip 91 for a distance of the separation from the inner wall 21.

Although the separation portion 43 is formed integrally with the body portion 41 in the present embodiment, it is not limited thereto, and the separation portion 43 may be formed as a separate body, or the separation portion 43 itself may not be provided. Moreover, it is preferable for the separation portion 43 to be configured with a high conductivity material such as platinum, rhodium, gold, silver, copper and titanium in order to facilitate the conduction of heat energy from the inner wall 21 to the body portion 41.

The dimension of the separation portion 43, i.e. the distance between the high radiation portion 40A and inner wall 21, may be appropriately set by taking into consideration the efficiency of heat conduction from the inner wall 21 to the body portion 41 and the efficiency of heat radiation from the body portion 41 to the tip 91. That is to say, if the dimension of the separation portion 43 is too large, the heat energy to be conducted from the inner wall 21 to the body portion 41 is likely to decrease, and if too small, on the other hand, the heat energy to be conducted from the body portion 41 to the tip 91 is likely to decrease.

### Operational Effect

According to the present embodiment, the following operational effects can be achieved in addition to those achieved by the aforementioned first embodiment.

Since the distance between the tip 91 of the flow path 90 and the high radiation portion 40A is small, the radiated heat energy reaches the tip 91 with high efficiency. This makes it possible to suppress the occurrence of striae and the deterioration of optical properties more sufficiently.

### Third Embodiment

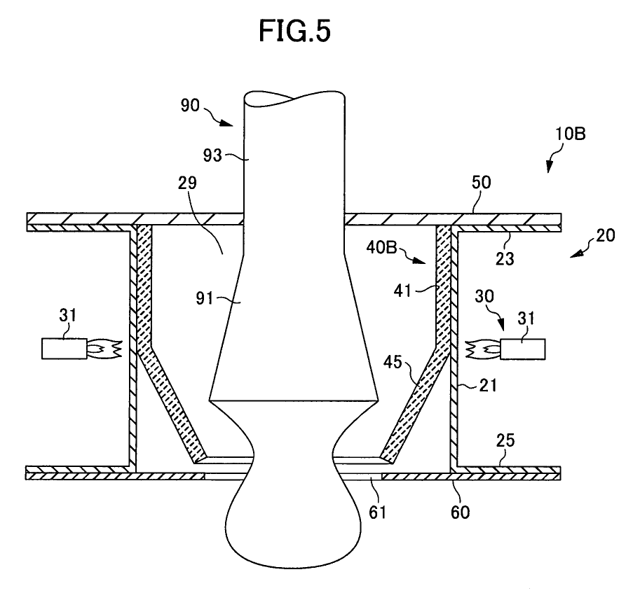

FIG. 5 is a diagram showing a schematic configuration of a heating apparatus 10B according to a third embodiment of the present invention. The present embodiment is different from the first embodiment in the configuration of a high radiation portion 40B.

That is to say, the high radiation portion 40B further includes a protruding portion 45 that protrudes inwardly. More specifically, the protruding portion 45 is tilted inwardly from the inner wall 21 (in other words, toward the center of the entry hole 29) at a predetermined angle. When such a heating apparatus 10B is used, the protruding portion 45 becomes closer to the tip 91 for the height of the protrusion.

It should be noted that, though the protruding portion 45 is integrally connected to the bottom edge of the body portion 41 (in other words, the edge opposite to the high conductivity portion 50) in the present embodiment, the protruding portion 45 may be formed as a separate body. Moreover, although not shown, the bottom edge of the protruding portion 45 may be connected to the inner wall 21 via a high conductivity member, thereby making it possible to secondarily heat the protruding portion 45 that is less likely to be heated due to the separation from the inner wall 21.

### Operational Effect

According to the present embodiment, the following operational effects can be achieved in addition to those achieved by the aforementioned first embodiment.

The protruding portion 45 is arranged in the vicinity of the tip 91 when the heating apparatus 10B is used. As a result, a larger amount of heat energy reaches the tip 91, thereby efficiently heating the tip 91. Therefore, it is possible to suppress the occurrence of striae and the deterioration of optical properties more sufficiently.

### MODIFIED EXAMPLES

The present invention is not limited to the aforementioned embodiments, and modifications and improvements within the scope which can achieve the object of the present invention are included in the present invention. For example, modified examples include the following.

### Modified Example 1

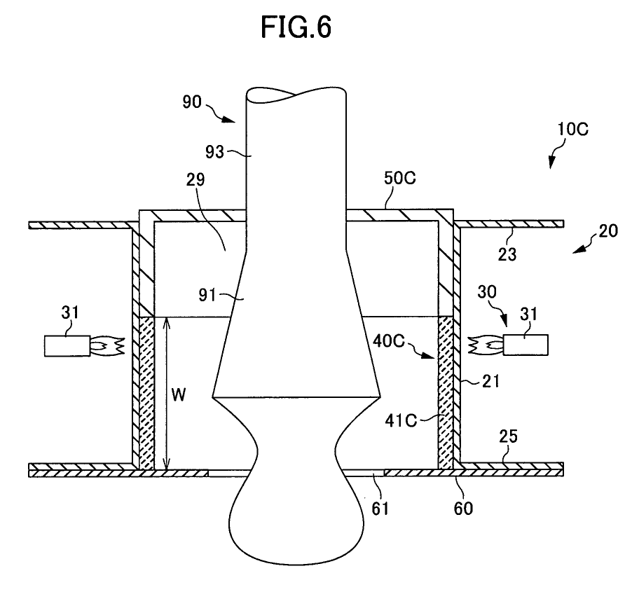

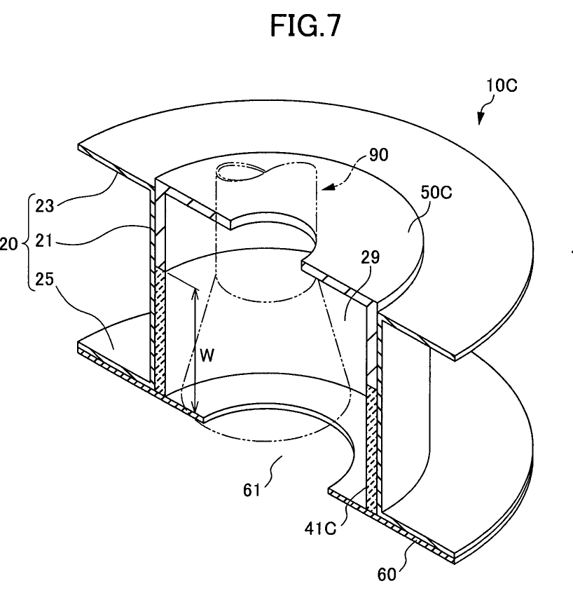

FIG. 6 is a diagram showing a schematic configuration of a heating apparatus 10C according to a modified example of the present invention. FIG. 7 is a cutaway perspective view of FIG. 6. This modified example is different from the aforementioned embodiments in the configuration of a high radiation portion 40C and a high conductivity portion 50C.

That is to say, a body portion 41C of the high radiation portion 40C is provided to a part of the inner wall 21, i.e. only a lower surface (the lower wall 25 side) of the inner wall 21 in this modified example. Moreover, the high conductivity portion 50C bends in the middle thereof, and the portion thereof is provided on a part of the surface of the inner wall 21, i.e. the upper surface (the upper wall 23 side) of the inner wall 21 in the present modified example. As a result, the heat energy generated by heating the inner wall 21 is conducted directly to the body portion 41C or the high conductivity portion 50C.

When described in more detail, the high conductivity portion 50C is provided on substantially the entire surface on which the body portion 41C is not provided. As a result, the heat energy of the inner wall 21 is completely conducted to the body portion 41C or the high conductivity portion 50C. However, the contact relationship between the inner wall 21 and the high radiation portion 40C as well as the high conductivity portion 50C may be appropriately set by taking into consideration the heat radiation to the tip 91 and the heat conduction to the base 93.

It should be noted that, although the upper wall 23 is exposed to the outside atmosphere in this modified example, the upper wall 23 may be covered with a heat insulating member. As a result, the cooling of the inner wall 21 via the upper wall 23 is suppressed.

### Modified Example 2

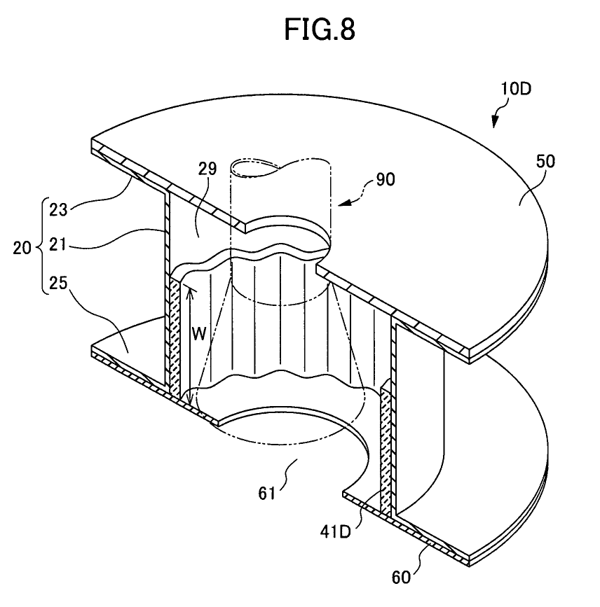

FIG. 8 is a cutaway perspective view of a heating apparatus 10D according to another modified example of the present invention. The present modified example is different from the aforementioned embodiments in the configuration of a high radiation portion 40D.

That is to say, a body portion 41D of the high radiation portion 40D has a substantially constant dimension W in the direction in which the inner wall 21 extends, but each of the top edge (the upper wall 23 side) and the bottom edge (the lower wall 25 side) of the body portion 41D has irregularities. As a result, the high radiation portion 40D is provided in different ranges in the direction in which the inner wall 21 extends.

### Alternatives

In addition, in the glass manufacturing method in the aforementioned embodiments, although the high radiation portion 40 is arranged so as to face the tip 91 as well as a lower part thereof with a distance therebetween, the inner wall 21 may be arranged in place of the high radiation portion 40. In this case, although the radiation efficiency of the heat energy is decreased, it is possible to secure sufficient heating of the tip 91, by enhancing the extent of heating by the heating portions 30, or by narrowing the distance between the inner wall 21 and the tip 91. As a result, it is not necessary to provide the high radiation portion 40, thereby making it possible to reduce the number of parts.

We claim:

1. A heating apparatus used for heating a flow path for flowing out molten glass, the apparatus comprising:
an inner wall which forms an entry hole that a tip of the flow path can enter;
a heating means for heating the inner wall; and
a high radiation portion made of a high emissivity material,
wherein the high radiation portion is arranged so as to face the tip of the flow path as well as a lower part thereof with a space therebetween.

2. The apparatus according to claim 1, wherein the high radiation portion is provided on a surface of the inner wall.

3. The apparatus according to claim 1, wherein the high radiation portion is provided to be separated from the inner wall, and is arranged so as to be positioned between the inner wall and the tip of the flow path as well as a lower part thereof.

4. The apparatus according to claim 1, wherein the high radiation portion is provided over an entirety in a circumferential direction of the inner wall.

5. The apparatus according to claim 4, wherein the high radiation portion has a substantially constant dimension in a direction in which the inner wall extends.

6. The apparatus according to claim 5, wherein the high radiation portion is provided in a substantially constant range in the direction in which the inner wall extends.

7. The apparatus according to claim 1, wherein the high radiation portion has a protruding portion that protrudes inwardly.

8. The apparatus according to claim 1, further comprising a high conductivity portion made of a high conductivity material and to be heated, wherein the high conductivity portion is connected to a base side of the flow path to enable heat conduction.

9. The apparatus according to claim 8, wherein the high conductivity portion is a part of the inner wall or a part that is connected to the inner wall to enable heat conduction.

10. The apparatus according to claim 9, wherein the high conductivity portion is a non-inner-wall portion that is connected to the inner wall to enable heat conduction.

11. The apparatus according to claim 1, wherein the high emissivity material has an emissivity of at least 0.4.

12. A glass manufacturing apparatus, comprising:
a flow path for flowing out molten glass;
the heating apparatus according to claim 1; and
a mold,
wherein the high radiation portion is arranged so as to face a tip of the flow path as well as a lower part thereof with a space therebetween, and
wherein the mold molds molten glass flowed out of the flow path.

13. An optical element manufacturing apparatus, comprising:
the glass manufacturing apparatus according to claim 12; and
a precision press apparatus that performs precision pressing of glass manufactured by the glass manufacturing apparatus.

14. A glass manufacturing method in which molten glass is flowed out of a tip of a flow path to manufacture glass, the method comprising steps of:
arranging a target heated surface, which is to be heated, so as to face the tip of the flow path as well as a lower part thereof with a space therebetween; and
heating the target heated surface.

15. The method according to claim 14, comprising steps of:
providing a high radiation portion made of a high emissivity material to the target heated surface;
arranging the high radiation portion so as to face the tip of the flow path as well as a lower part thereof with a space therebetween; and
heating the high radiation portion.

16. The method according to claim 15, wherein a material with an emissivity of at least 0.4 is used as the high emissivity material.

17. The method according to claim 15, wherein the high radiation portion is arranged over an entirety in a circumferential direction of the flow path.

18. The method according to claim 17, wherein the high radiation portion is arranged in a substantially constant dimension in a direction in which the flow path extends.

19. The method according to claim 18, wherein the high radiation portion is arranged in a substantially constant range in a direction in which the flow path extends.

20. The method according to claim 14, wherein the target heated surface is arranged so as to protrude toward the tip of the flow path as well as a lower part thereof.

21. The method according to claim 14, further comprising steps of:
connecting a high conductivity portion made of a high conductivity material to a base side of the flow path to enable heat conduction; and
heating the high conductivity portion directly or indirectly.

22. The method according to claim 21, wherein the high conductivity portion is connected to a part of the target heated surface or a part that is connected to the target heated surface to enable heat conduction.

23. The method according to claim 22, wherein the high conductivity portion, which is positioned on a non-facing portion that does not face the flow path, is connected to a base side of the flow path to enable heat conduction.

24. An optical element manufacturing method, comprising a step of performing precision press molding of the glass manufactured by the glass manufacturing method according to claim 14.
